(19) United States
(12) Patent Application Publication
(10) Pub. No.: US 2005/0010443 A1
(43) Pub. Date: Jan. 13, 2005

(54) Methods for online clinical trial recruiting

(75) Inventor: Gary K. Zammitt, Norwalk, CT (US)

Correspondence Address: MANATT PHELPS AND PHILLIPS;ROBERT D. BECKER, 1001 PAGE MILL ROAD, BUILDING 2, PALO ALTO, CA, 94304, US

(73) Assignee: CLINILABS, INC., NEW YORK, NY (US)

(21) Appl. No.: 10/845,697

(22) Filed: May 14, 2004

Related U.S. Application Data
(60) Provisional application No. 60/470,953, filed on May 14, 2003.

(51) Int. Cl. G06F 17/60; H04K 1/00; H04L 9/00; G09B 3/00; G09B 7/00

(52) U.S. Cl. 705/2; 705/14; 434/322

(57) ABSTRACT

In a clinical trial recruiting process, online advertisements are strategically placed on websites. When a respondent clicks the advertisements, a screening process, optionally a multiple level screening process, is conducted to screen the respondent for participation in a clinical trial program. Contact information and other data points are collected from successfully screened respondents, securely stored in a data storage unit to maintain the confidentiality and readiness of the same for auditing, and transmitted to a clinical trial conducting organization. The effectiveness of the online advertisement is periodically evaluated to maximize recruitment efficiency.

### RELATED APPLICATIONS

This application claims the benefit under 35 U.S.C. § 119(e) of Provisional Application Ser. No. 60/470,953, filed May 14, 2003.

### FIELD OF THE INVENTION

The present invention relates, in general, to online data collection and processing and, more specifically, to clinical trial participant recruitment and screening through networks.

### BACKGROUND OF THE INVENTION

Clinical trial programs are essential in the advancement of medicine and health care. They provide heath care researchers and professionals with valuable information about the efficacy and possible adverse effects of various treatments. They also provide patients and their physicians with access to new and alternative treatments.

With the widespread use of the Internet, patients and their physicians increasingly rely on the Internet in seeking information about heath care, disease prevention and treatment. Health care providers and researchers would like to take advantage of the Internet in recruiting and screening potential participants for clinical trial programs. For example, about 92% of physicians in the United States and about 80% of physicians in Europe who responded to a survey are using or have interests in using the Internet to find information about clinical trials for their patients. Another survey indicates that more than 68% of adults in the United States have sought health related information on the Internet. In addition, more than 40% of clinical trial program participants indicate that they have used online resources to obtain information about research programs.

Accordingly, it would be advantageous to provide a process for online recruitment and screening of potential participants for a clinical trial program. It is desirable for the process to be able to reach targeted audiences through the Internet. It is also desirable to be able to screen and enroll the potential participants efficiently. It would be of further advantage to be able to securely protect the privacy of the potential participants.

### BRIEF SUMMARY OF THE INVENTION

In accordance with one embodiment, the present invention provides a process and a computer executable program for online data collection and processing. The computer executable program may be stored on a computer readable medium. A specific embodiment of the present invention provides a process and a computer executable program for participant recruitment and screening through the Internet.

In accordance with another embodiment of the present invention, a process for recruiting participants for a clinical program includes online banner advertisements strategically targeted to audiences according to their demographic profiles and/or geographic profiles.

In accordance with another embodiment of the present invention, the recruiting process uses photographic images or icons to guide the respondents through different levels of an automated screening process for the potential participants. In this embodiment, the recruiting process employs an automated progressive screening method that requires the respondents to pass plural levels of screening in order to qualify for participation in a clinical trial program.

In accordance with another embodiment of the present invention, the recruiting process automatically generates communications, such as e-mail messages, to the organization conducting the clinical trial indicating the respondents' interest and qualification in participating in the clinical trial.

In accordance with another embodiment of the present invention, the data generated by the recruiting process is securely stored in a data storage unit within the organization conducting the clinical. The data is not shared with sources outside of the organization to maintain the confidentiality and readiness for auditing.

In accordance with another embodiment of the present invention, the recruiting process periodically evaluates the effectiveness of the advertisement and modifies the advertising strategy to maximize recruitment efficiency.

### BRIEF DESCRIPTION OF THE DRAWINGS

The several figures of the drawings illustrate some of the currently preferred embodiments of the invention, in which:

FIG. 1 illustrates an online recruiting process in accordance with one embodiment of the present invention;

FIG. 2 illustrates an online screening process in accordance with another embodiment of the present invention; and

FIG. 3 illustrates an online recruiting process in accordance with yet another embodiment of the present invention.

### DETAILED DESCRIPTION OF THE DRAWINGS

Various embodiments of the present invention are described hereinafter with reference to the figures. Elements of like structures or function are represented with like reference numerals throughout the figures. The figures are only intended to facilitate the description of some embodiments of the invention. They are not intended as an exhaustive description of the invention or as a limitation on the scope of the invention. In addition, an aspect described in conjunction with one embodiment of the present invention is not necessarily limited to that embodiment and can be practiced in conjunction with any other embodiments of the invention.

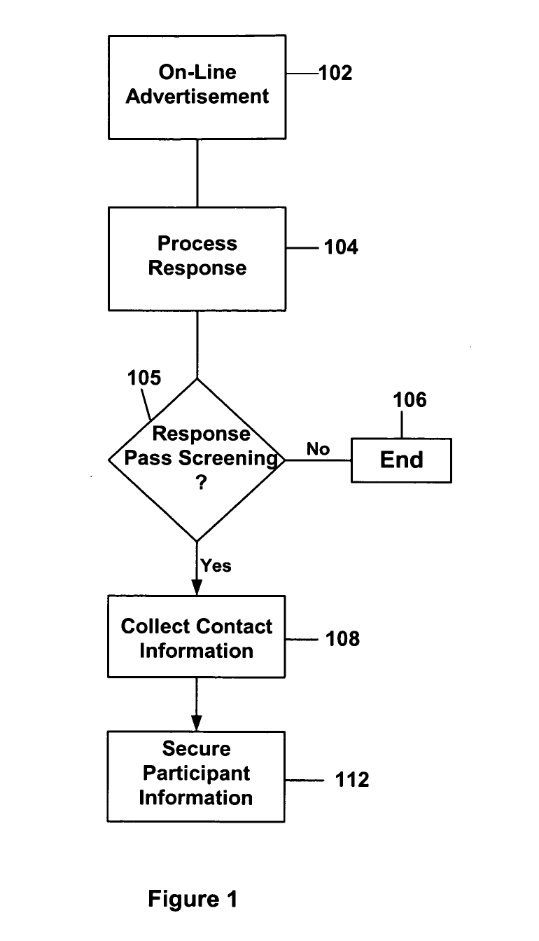

FIG. 1 illustrates an online recruiting process 100 in accordance with one embodiment of the present invention. By way of example, process 100 recruits participants for a clinical trial program through the Internet. However, this is not intended as a limitation on the scope of the present invention. Process 100 is applicable in applications that include soliciting and processing responses through a network, e.g., Internet, Intranet, LAN, and the like.

In step 102, advertisements about the clinical trial program are placed on network sites. Preferably, the advertisements include banners, icons, and/or other images depicting one or more specific disorders for which the clinical trial program is conducted. For example, if the clinical trial program concerns a study in the area of depression, the advertisement may include an image that depicts a person who appears depressed. The advertisement may also include a logo of the organization that is conducting the program or recruiting for participation in a clinical trial program.

In accordance with an embodiment of the present invention, the advertisements for the clinical trial program are strategically positioned on websites that target specific demographic profiles. For example, if the clinical trial program is for the study of Alzheimer's disease, the advertisements are preferably placed on the websites that seniors frequently visit. The advertisement may also be placed on websites that appear in specific geographic locations if the disorder under study has certain geographic profiles or concentration and/or the recruitment seeks to reach certain basis of geography based upon the geographic recruitment goals of the clinical trial program.

When a potential participant or respondent viewing the advertisement clicks a link in the advertisement to access webpage, process 100 starts a screening process in step 104. The webpage may be a page on a website that hosts the advertisement. Alternatively, the webpage is a page on the website operated by an organization that conducts the clinical trial program recruitment. The clinical trial program participant screening step 104 includes questions to be answered by the respondents. Based on the responses, process 100, in step 105, determines whether the respondent qualifies to be a participant for the clinical trial program.

If the responses suggest that the respondent is not eligible to participate in the clinical trial, process 100 informs the respondent and terminates process 100 in step 106. In accordance with an embodiment of the present invention, process 100 makes suggestions that the respondent consult his/her primary care physician regarding the health condition.

If the responses suggest that the respondent is eligible to participate in the clinical trial, process 100, in a step 108, informs the respondent about his/her eligibility to the clinical trial program. In addition, process 100 collects contact information, e.g., respondent's home address, telephone number, e-mail address, the name and address of the respondent's primary care physician, and so on, from the respondent. In accordance with one embodiment, process 100 suggests that the respondent seek advice from his/her primary care physician in response to the respondent refusing or otherwise failing to provide the contact information.

In step 112, process 100 transmits and securely stores the responses and contact information of eligible respondents on a data storage unit operated by the organization that conducts the clinical trial program recruitment. In one embodiment, steps 104, 105, and 108 of process 100 are performed on an outside website other than the website operated by the organization. In this embodiment, an e-mail including the data about the respondent is sent to the organization website, where it is securely stored. In addition, all data about the respondent are deleted from the outside website. In another embodiment, steps 104, 105, and 108 of process 100 are performed on a secure organization operated website. In this embodiment, the data is transmitted to the data storage unit for secure storage.

In accordance with a preferred embodiment, the storage and management of the data generated in process 100 is secured to provide the privacy of the respondents. In one embodiment, the data is managed in accordance with Health Insurance Portability and Accountability Act (HIPAA) and the confidentiality, security, and audit requirements of the federal regulation 21 CFR Part 11.

In accordance with an embodiment of the present invention, the effectiveness of the advertisement is analyzed or evaluated periodically, e.g., daily, weekly, monthly, and so on. In one embodiment, the numbers of clicks generated at various steps in process 100 is evaluated for each advertisement. The evaluation is used for modifying the advertising strategy or format to achieve optimum efficiency and maximize program participant recruitment.

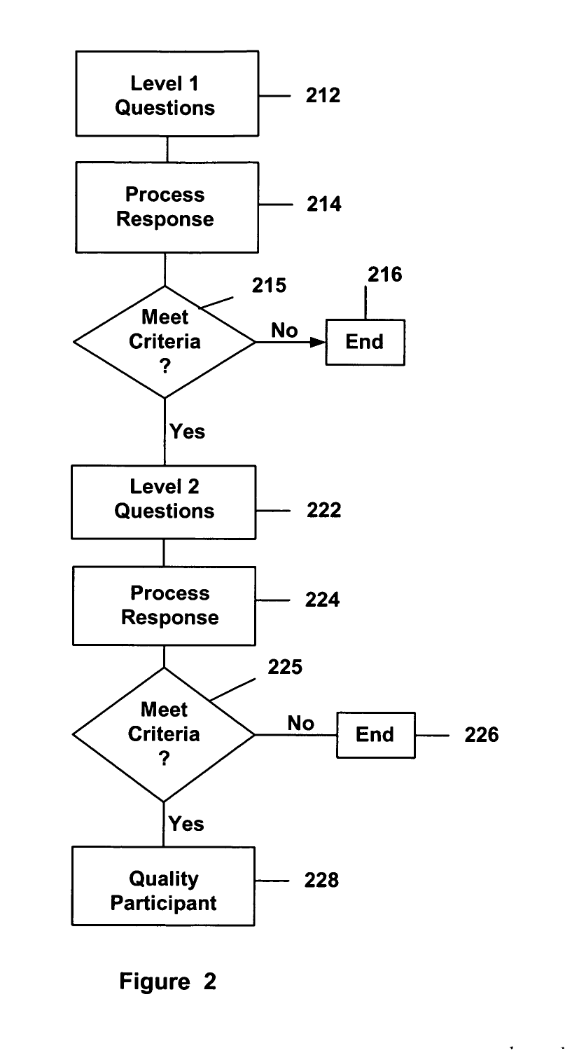

FIG. 2 illustrates an online screening process 200 in accordance with the present invention. By way of example, process 200 is described herein as performing screening steps 104 and 105 of process 100 illustrated in FIG. 1. In accordance with an embodiment of the present invention, process 200 is a multiple level screening process.

During the first level of screening, a respondent who clicks on the advertisement banner, image, or icon is directed to a landing site that presents a short list of symptoms that are characteristic of the disorder in which the respondent has expressed interests (step 212). For example, the respondent may be presented with the following: “Do you suffer from mood swings? Have you lost interest in your usual activities? Have you lost enjoyment for things that you usually find pleasurable?” A photographic image or icon depicting a specific disorder may be used.

In step 214, the respondent's responses to the short list of questions are processed. If the responses do not meet a predetermined criterion (step 215), the screening process terminates in step 216 at the first level of screening. If the responses meet the predetermined criterion, process 200 proceeds to the second level of screening. In other words, the respondent who passes the first level of screening is directed to the second level of screening.

At the second level of screening, the respondent is presented with a questionnaire (step 222) that is divided into a plurality of sections. Each section includes one or more questions. In a preferred embodiment, the questionnaire includes three to five sections and each question includes approximately five questions. However, the number of sections and the number of questions in each section can be adjusted for different screening processes. Preferably, the questionnaire is not too long for the average attention span of the target audience. Successful completion of each section enables the respondent to proceed to the next section.

In step 224, the respondent's responses to the questionnaire are processed. If the responses do not meet a predetermined criterion (step 225), the screening process terminates in step 226. If the responses meet the predetermined criterion, process 200 proceeds to qualify the respondent for participation in a clinical trial program (step 228). In accordance with one embodiment of the present invention, the respondent is directed to step 108 of process 100 shown in FIG. 1.

It should be understood that process 200 is not limited to including two screening levels. In accordance with alternative embodiments of the present invention, screening process 200 may include any plural number of screening levels, e.g., three, four, five, and so on. Successful completion of one level enables the respondent to proceed to the next level. It should also be understood that screening process 200 is not limited to serving as steps 104 and 105 in program participant recruiting process 100 illustrated in FIG. 1. In accordance with the present invention, screening process 200 can be used for any interactive data processing process.

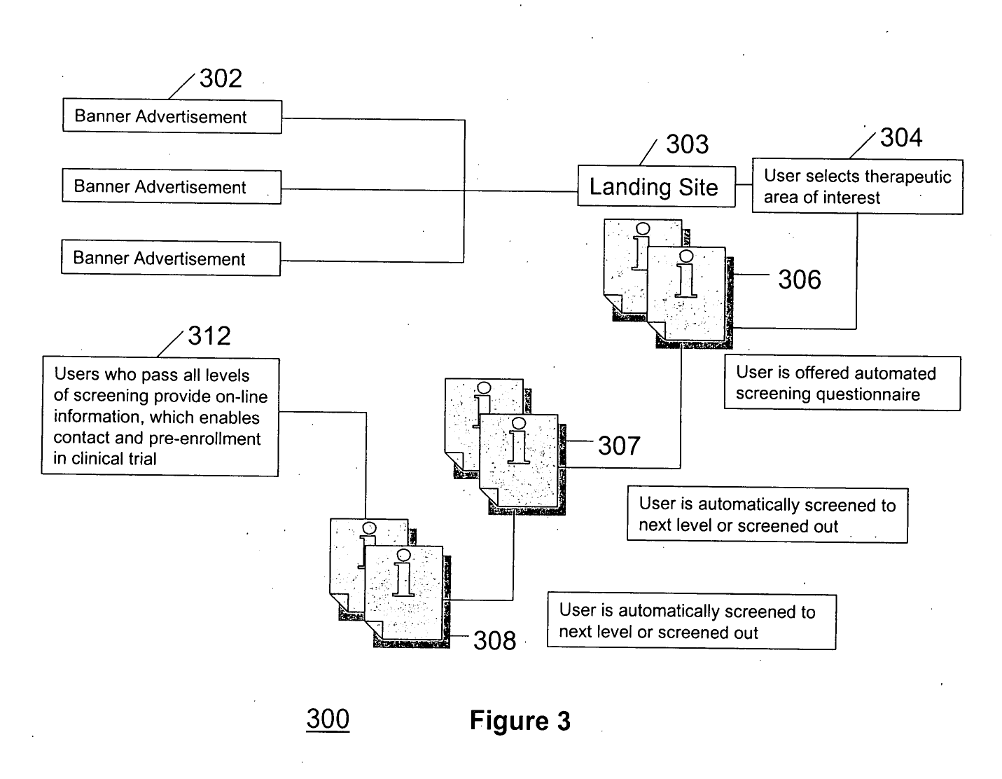

FIG. 3 illustrates an online recruiting process 300 in accordance with the present invention. By way of example, process 300 recruits participants in a clinical trial program through the Internet. However, this is not intended as a limitation on the scope of the present invention. Process 300 is applicable in applications that include soliciting and processing responses through a network.

In step 302, advertisements about the clinical trial program are placed on various websites. Preferably, the advertisements include banners, icons, and/or other images depicting a specific disorder, for which the clinical trial program is conducted. The advertisement may also include logos of the organizations that are conducting the program or recruiting for participation in a clinical trial program. In accordance with an embodiment of the present invention, the advertisements for the clinical trial program are strategically positioned on websites that target specific demographic profiles. The advertisement may appear in specific geographic locations if the disorder under study has a geographic profile or the clinical trial program has a geographic recruitment goal.

When a potential participant or user viewing the advertisement clicks a link in the advertisement, the user is directed to a landing site (step 303) that conducts the screening process of the potential participants for participation in a clinical trial program. The landing site may be located on a website that hosts the advertisement. Alternatively, the landing site is located on a network server operated by an organization that conducts the clinical trial program recruitment.

In step 304, the user selects a therapeutic area of interest, e.g., treatment for depression, insomnia, bipolar disorder, cancer, high blood pressure, and so on. Based on the user selection, process 300, in step 306, presents the user with a predetermined screening questionnaire, which includes one or more questions related to the user selected therapeutic area of interest. The user's response to the questionnaire may disqualify the user from the clinical trial program, in which case process 300 informs the user and preferably suggests that user seek advice from his/her primary care physician.

If the user passes the questionnaire presented in step 306, process 300 directs the user to the next level of screening (step 307). Optionally, process 300 includes a third level of screening (step 308) for the user in response to the user passing the second level of screening. It should be understood that process 300 may include additional levels of screening not shown in FIG. 3.

If the user is determined to be eligible to participate in the clinical trial by passing all levels of screening, process 300, in a step 312, informs the user about his/her eligibility to the clinical trial program. In addition, process 300 collects contact information data, e.g., home address, telephone number, e-mail address, the name and address of the user's primary care physician, and so on., from the user. This data enables the organization to contact the user and enroll the user into the clinical trial program that the user selects in step 304. In accordance with one embodiment, process 300 suggests that user seek advice from his/her primary care physician in response to the user refusing or otherwise failing to provide the contact information.

Preferably, process 300 transmits and securely stores the responses and contact information data of eligible users on a data storage unit operated by the organization that conducts the clinical trial program recruitment. In one embodiment, an e-mail including the data about the user is sent to the organization, where it is securely stored.

In accordance with a preferred embodiment of the present invention, the storage and management of the data generated in process 300 is secured to provide the privacy of the users. In one embodiment, the data is managed in accordance with the confidentiality, security, and audit requirements of HIPAA and 21 CFR Part 11.

In accordance with another embodiment of the present invention, the effectiveness of the advertisement is periodically analyzed or evaluated. In one embodiment, the numbers of clicks generated at various steps in process 300 is evaluated for each advertisement. The evaluation is used for modifying the advertising strategy or format to achieve optimum efficiency and maximize program participant recruitment.

While the invention is susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions, and equivalents falling within the spirit and scope of the invention.

1. A method for screening a candidate for a clinical trial relating to a disorder, comprising:
providing an electronic notice of the clinical trial at a first network location accessible by the candidate, the electronic notice including an indication of the disorder and being configured to enable the candidate to submit an indication of interest in the disorder;
directing the candidate to a second network location upon submission of the indication of interest in the disorder by the candidate;
collecting at least one qualifying data point from the candidate at the second network location; and
determining whether or not the candidate meets at least one predetermined criterion for the clinical trial corresponding to the at least one qualifying data point.

2. The method according to claim 1, wherein collecting at least one qualifying data point comprises:
collecting at least one first data point;
passing the candidate to a subsequent data collection step if the at least one first data point meets a first predetermined criterion for the clinical trial; and
performing the subsequent data collection step.

3. The method according to claim 2, wherein performing the subsequent data collection step comprises:
collecting at least one second data point;
passing the candidate to a subsequent qualifying step if the at least one second data point meets a second predetermined criterion for the clinical trial; and
conducting the subsequent qualifying step.

4. The method according to claim 1, further comprising:
providing a qualification status notice to the candidate, the qualification status notice informing the candidate of a qualification status based on a determination of whether or not the candidate meets the at least one predetermined criterion for the clinical trial corresponding to the at least one qualifying data point.

5. The method according to claim 1, further comprising:
collecting contact information from the candidate if the candidate meets the at least one predetermined criterion for the clinical trial.

6. The method according to claim 5, further comprising:
transmitting collected contact information to an clinical trial conducting organization.

7. The method according to claim 5, further comprising:
transmitting collected contact information and the at least one qualifying data point to a clinical trial conducting organization.

8. The method according to claim 5, further comprising storing collected contact information.

9. The method according to claim 5, further comprising storing collected contact information and the at least one qualifying data point.

10. The method according to claim 1, wherein the disorder comprises at least one of depression, insomnia, bipolar disorder, cancer, hypertension, and Alzheimer's disease.

11. The method according to claim 1, wherein the electronic notice of the clinical trial comprises at least one of a search result, a text message, a hyperlink, a banner advertisement, an image depicting the disorder, an icon depicting the disorder, or an identifier of a clinical trial conducting organization.

12. The method according to claim 1, wherein the first network location comprises an Internet site.

13. The method according to claim 12, wherein the Internet site comprises a World Wide Web site.

14. The method according to claim 1, wherein the first network location comprises a network location accessible by a browser application.

15. The method according to claim 1, wherein the indication of interest in the disorder comprises a selection of the electronic notice by the candidate.

16. The method according to claim 14, wherein the selection of the electronic notice comprises a click on the electronic notice by the candidate.

17. The method according to claim 1, wherein the second network location is at a location common to the first network location.

18. The method according to claim 1, wherein the second network location is located at a second network location distinct from the first network location.

19. The method according to claim 1, wherein the second network location is located at a clinical trial administrator network location.

20. The method according to claim 1, further comprising providing secure communication between the candidate and the second network location.

21. The method according to claim 1, wherein all personal health information collected from the candidate is managed in compliance with applicable laws and regulations.

22. The method according to claim 1, further comprising managing all personal health information collected from the candidate in compliance with the Health Insurance Portability and Accountability Act and Part 11 of Title 21 of the Code of Federal Regulations.

23. The method according to claim 1, wherein collecting at least one qualifying data point comprises:
presenting to the candidate at least one query relating to at least one symptom of the disorder;
and collecting a query response to the at least one query from the candidate.

24. The method according to claim 1, wherein collecting at least one qualifying data point comprises collecting demographic data from the candidate.

25. The method according to claim 1, wherein collecting at least one qualifying data point comprises collecting geographic data from the candidate.

26. The method according to claim 1, wherein the at least one predetermined criterion comprises at least one of a symptom criterion, a response criterion, a demographic criterion, or a geographic criterion.

27. The method according to claim 4, wherein providing the qualification status notice comprises providing a success indication to the candidate if the candidate meets the at least one predetermined criterion for the clinical trial.

28. The method according to claim 27, wherein providing a success indication comprises providing an indication of successful screening for the clinical trial and a follow-up notice that a clinical trial conducting organization will contact the candidate for further screening for the clinical trial.

29. The method according to claim 4, wherein providing the qualification status notice comprises providing a consultation indication to the candidate if the candidate does not meet the at least one predetermined criterion for the clinical trial.

30. The method according to claim 29, wherein the consultation indication advises the candidate to seek advice from a healthcare provider.

31. The method according to claim 4, wherein providing the qualification status notice comprises providing the qualification status notice to the candidate at the second network location after determining whether or not the candidate meets at least one predetermined criterion for the clinical trial.

32. The method according to claim 4, wherein providing the qualification status notice comprises providing the qualification status notice to the candidate via e-mail after determining whether or not the candidate meets at least one predetermined criterion for the clinical trial.

33. The method according to claim 5, wherein collecting contact information from the candidate comprises collecting at least one of a home address, a telephone number, an e-mail address, or contact information for the candidate's healthcare provider.
